(19) United States
(12) Patent Application Publication
(10) Pub. No.: US 2019/0301199 A1
(43) Pub. Date: Oct. 3, 2019

(54) DOOR CLOSURE AND LOCK STATE DETECTION

(71) Applicant: TEXAS INSTRUMENTS INCORPORATED, Dallas, TX (US)

(72) Inventor: Daniel Brian ANDERSEN, Riverside, CA (US)

(21) Appl. No.: 16/133,787

(22) Filed: Sep. 18, 2018

Related U.S. Application Data
(60) Provisional application No. 62/648,418, filed on Mar. 27, 2018.

(51) Int. Cl. E05B 17/22; E05B 47/00

(52) U.S. Cl. CPC E05B 17/22; E05B 15/0205; E05B 47/0011

(57) ABSTRACT

A method and apparatus for determining whether a door is closed and locked. A door lock system includes a bolt, transmitter circuitry, and receiver circuitry. The bolt includes a first end that is extendible to engage a strike plate. The first end includes an opening, and channel extends from the opening longitudinally through the bolt. The transmitter circuitry is coupled to the bolt, and is configured to transmit a signal into the channel. The receiver circuitry is coupled to the bolt, and is configured to detect a reflection of the signal returned through the channel.

### CROSS-REFERENCE TO RELATED APPLICATIONS

The present application claims priority to U.S. Provisional Patent Application No. 62/648,418, filed Mar. 27, 2018, titled “Novel Method to Determine if a Door is Closed and Locked,” which is hereby incorporated herein by reference in its entirety.

### BACKGROUND

Door locks are used to provide secure access in or to residential, business, or other structures. Electronic door locks include a number of features that enhance user convenience. Such features include keyless access, remote access, and remote state monitoring.

### SUMMARY

A method and apparatus for determining whether a door is closed and locked are disclosed herein. In one example, a door lock system includes a bolt, transmitter circuitry, and receiver circuitry. The bolt includes a first end that is extendible to engage a strike plate. The first end includes an opening, and a channel that extends from the opening longitudinally through the bolt. The transmitter circuitry is coupled to the bolt, and is configured to transmit a signal into the channel. The receiver circuitry is coupled to the bolt, and is configured to detect a reflection of the signal returned through the channel.

In another example, a method includes transmitting a signal through an opening at an end of a bolt of a door lock. A reflection of the signal is received through the opening. Whether the door is closed and locked is determined based on the reflection of the signal.

In a further example, a door lock includes a bolt, an optical emitter, and an optical detector. The bolt includes a first end, a second end, an aperture, and a channel. The second end is opposite the first end. The aperture is disposed in the first end. The channel extends from the aperture through the bolt. The optical emitter is aligned with channel. The optical detector is aligned with the channel.

### BRIEF DESCRIPTION OF THE DRAWINGS

For a detailed description of various examples, reference will now be made to the accompanying drawings in which:

FIG. 1 shows a schematic diagram for an example of a door lock system in accordance with the present disclosure;

FIG. 2 shows a block diagram for an example of control circuitry suitable for use in a door lock system in accordance with the present disclosure; and

FIG. 3 shows a flow diagram for a method for determining whether a door is closed and locked in accordance with the present disclosure.

### DETAILED DESCRIPTION

Certain terms have been used throughout this description and claims to refer to particular system components. As one skilled in the art will appreciate, different parties may refer to a component by different names. This document does not intend to distinguish between components that differ in name but not function. In this disclosure and claims, the terms “including” and “comprising” are used in an open-ended fashion, and thus should be interpreted to mean “including, but not limited to . . . .” Also, the term “couple” or “couples” is intended to mean either an indirect or direct wired or wireless connection. Thus, if a first device couples to a second device, that connection may be through a direct connection or through an indirect connection via other devices and connections. The recitation “based on” is intended to mean “based at least in part on.” Therefore, if X is based on Y, X may be a function of Y and any number of other factors.

While electronic door locks provide a number of convenient features, such as remote state reporting, some implementations of an electronic door lock are incapable of detecting the state of a door in which the lock is installed. For example, an implementation of an electronic door lock may be able to accurately determine whether a bolt of the lock is extended or retracted and define the state of the lock based on the position of the bolt. However, such implementations may be unable to determine whether the door is closed or open. If the bolt is extended and the door is not closed, then the lock is not providing access security. Some security systems include door state monitoring circuitry, such as contacts on the door and door jamb to determine whether the door is closed or open.

Implementations of the door locks disclosed herein include circuitry within the door lock to determine whether a door is closed. In the door locks of the present disclosure, the bolt includes a longitudinal channel. A signal is emitted into the channel, and propagates through the channel to an opening at the end of the bolt. The signal exits the bolt and is reflected by a surface external to the bolt, such as the back wall of a door jamb recess behind the strike plate, or a back wall of the strike plate. The reflected signal enters the channel and is detected by circuitry of the door lock. The round-trip travel time of the signal is measured, and distance to the reflective surface is determined based on travel time. If the distance is approximately equal to a predetermined baseline distance, then the door is deemed to be closed. The baseline distance may be a distance measured when the door is known to be closed. Thus, implementations of the door lock disclosed herein determine whether a door is locked and closed without requiring the addition of components external to the door lock.

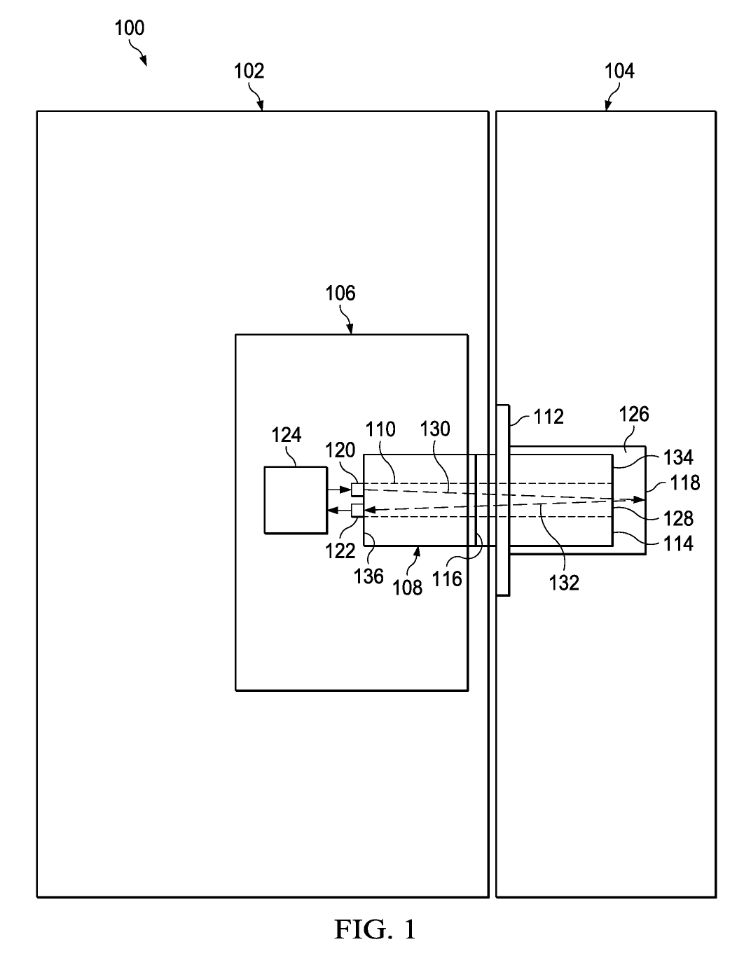

FIG. 1 shows a schematic diagram for an example of a door lock system 100 in accordance with the present disclosure. The door lock system 100 includes a door 102, a door jamb 104, and a door lock 106. The door lock 106 is installed on the door 102. The door jamb 104 includes a strike plate 112 and a recess 126 behind the strike plate 112. In some implementations, the recess 126 is part of the strike plate 112. The recess 126 includes a back wall 118. In some implementations, the back wall 118 is part of the strike plate 112.

The door lock 106 includes a bolt 108, a signal emitter 120, a signal detector 122, and control circuitry 124. The bolt 108 includes an opening or aperture 128 formed in a distal end 134 of the bolt 108. The bolt 108 also includes a channel 110 that extends longitudinally from the aperture 128 through the bolt 108. The bolt 108 (i.e., the distal end 134 of the bolt 108) may be extended to engage the strike plate 112 and lock the door 102, or retracted to unlock the door 102. In FIG. 1, the bolt 108 is shown to be extended by bolt end 114. The retracted state of the bolt 108 is illustrated by bolt end 116.

The signal emitter 120 and the signal detector 122 are coupled to the bolt 108 and positioned to emit signal into the channel 110 and receive reflected signal from the channel 110 respectively. For example, the signal emitter 120 and the signal detector 122 are positioned at a proximal end 136 of the bolt 108 and aligned with the channel 110, and the aperture 128 is provided at an opposite and distal end 134 of the bolt 108. In some implementations of the door lock system 100, the signal emitter 120 is an optical emitter, such as a light emitting diode, and the signal detector 122 is an optical detector, such as a photodiode. In some implementations of the door lock system 100, the signal emitter 120 is an acoustic emitter, such as a piezoelectric device, and the signal detector 122 is an acoustic detector, such as a piezoelectric device. Accordingly, the signal 130 is an optical signal or an acoustic signal in various implementations of the door lock 106.

The signal emitter 120 and signal detector 122 are coupled to the control circuitry 124. The control circuitry 124 controls the generation of signal 130 by the signal emitter 120 and receives reflected signal reflected signal 132, which is detected by the signal detector 122. For example, the control circuitry 124 generates an electrical signal and provides the electrical signal to the signal emitter 120 to be converted to an optical or acoustic signal 130.

Implementations of the door lock 106 include various components that have been omitted from FIG. 1 in the interest of clarity. For example, an implementation of the door lock 106 may include a handle, knob, and or actuator for extending and retracting the bolt 108, a power source such as a battery for powering the control circuitry 124, and other components.

When the door 102 is closed, the bolt 108 is aligned with strike plate 112 and the recess 126. The control circuitry 124 controls and/or monitors the position of the bolt 108. When the bolt 108 moves from the retracted position to the extended position (e.g., by operation of a knob, lever, motor, or other actuator), the control circuitry 124 detects extension of the bolt 108. For example, an implementation of the door lock 106 may include a Hall Effect sensor, or other sensor, that detects extension of the bolt 108. When the control circuitry 124 detects extension of the bolt 108, the control circuitry 124 initiates measurement of the distance between the back wall 118 and the signal emitter 120 or the signal detector 122. The control circuitry 124 triggers generation of the signal 130 by the signal emitter 120. The signal 130 travels through the channel 110, exits the bolt 108 at the aperture 128, and is reflected by the back wall 118. The reflected signal 132 enters the bolt 108 via the aperture 128 and travels through the channel 110 to the signal detector 122. The signal detector 122 detects the reflected signal 132 and provides an electrical signal to the control circuitry 124. The control circuitry 124 determines the time between transmission of the signal 130 and reception of the reflected signal 132. The control circuitry 124 determines the distance from the back wall 118 to the signal emitter 120 and/or the signal detector 122 based on the time. If the distance is approximately equal to (e.g., within +/−10% of) a baseline distance value, then the door 102 is deemed to be closed and locked. If the distance substantially differs from the baseline value then the door is deemed to be not closed and locked.

Implementations of the control circuitry 124 also analyze the reflected signal 132 to determine whether the environment in which the door lock 106 is operating has changed. Changes in the operating environment of the door lock 106 may indicate that the door lock 106 or its operating environment has been tampered with. The control circuitry 124 compares the amplitude and/or color content of the reflected signal 132 to baseline values acquired when the door lock 106 is initialized. A substantial difference in the amplitude and/or color content of the reflected signal 132 from the baseline values is indicative of a change in the operating environment of the door lock 106.

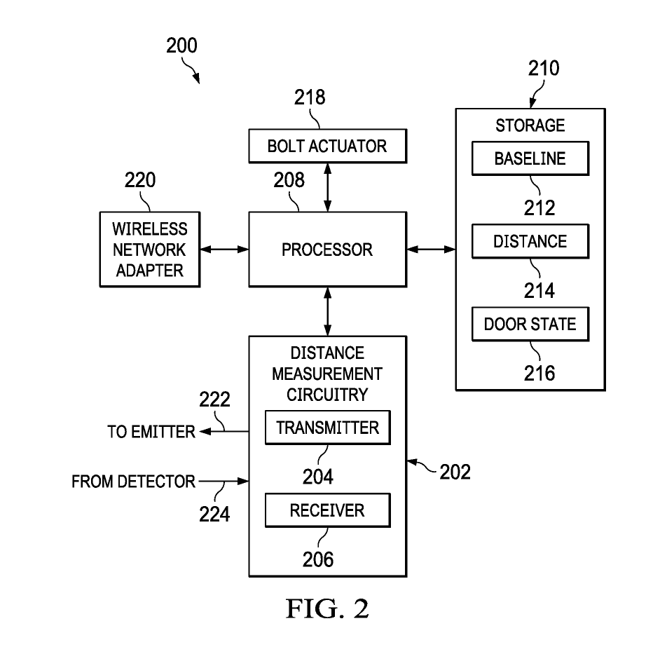

FIG. 2 shows a block diagram for an example of control circuitry 200 suitable for use in the door lock 106. The control circuitry 200 is an implementation of the control circuitry 124. The control circuitry 200 includes distance measurement circuitry 202, a processor 208, storage 210, a bolt actuator 218, and a wireless network adapter 220. The distance measurement circuitry 202 controls transmission of the signal 130 and processes the reflected signal 132 to determine time-of-flight of the signal 130 and the reflected signal 132. The distance measurement circuitry 202 is communicatively coupled to the processor 208 to allow transfer of control information from the processor 208 to the distance measurement circuitry 202 and transfer of time-of-flight information from the distance measurement circuitry 202 to the processor 208. In some implementations, the distance measurement circuitry 202 is coupled to the processor 208 via a serial interface, such as the inter-integrated circuit (I²C) bus.

The distance measurement circuitry 202 includes transmitter circuitry 204 and receiver circuitry 206. The output 222 couples the distance measurement circuitry 202 to the signal emitter 120, and the input 224 couples the distance measurement circuitry 202 to the signal detector 122. The transmitter circuitry 204 generates an electrical signal that is transmitted by the signal emitter 120 as the signal 130. The receiver circuitry 206 receives the electrical signal corresponding to the reflected signal 132 detected by the signal detector 122. The signal emitter 120 and the signal detector 122 may be considered part of the transmitter circuitry 204 and the receiver circuitry 206 respectively in some implementations. The distance measurement circuitry 202 measures the time difference between the signal generated by the transmitter circuitry 204 and the signal received by the receiver circuitry 206. The distance measurement circuitry 202 also measures the amplitude of the signal received by the receiver circuitry 206. Time-of-flight information, reflected signal amplitude information, and other information derived from the reflected signal 132 received by the receiver circuitry 206 is provided to the processor 208.

In some implementations of the control circuitry 200, the distance measurement circuitry 202 is implemented using an OPT3101 distance sensor circuit manufactured by TEXAS INSTRUMENTS, INC., or similar circuit.

The processor 208 is a microcontroller, or other microprocessor, in some implementations of the control circuitry 200. The processor 208 is coupled to the distance measurement circuitry 202, the storage 210, the bolt actuator 218, and the wireless network adapter 220. Based on information received from the distance measurement circuitry 202, the processor 208 determines whether the door 102 is closed and locked. The processor 208 executes instructions retrieved from the storage 210 to determine whether the door 102 is closed or open. In some implementations of the control circuitry 200, the storage 210 is provided on a same integrated circuit as the processor 208.

Implementations of the storage 210 include volatile storage such as random access memory, non-volatile storage (e.g., FLASH storage, read-only-memory, EEPROM), or combinations thereof. The storage 210 includes instructions that are executed by the processor 208 to determine whether the door 102 is open or closed. For example, the storage 210 includes baseline measurement 212, distance measurement 214, and door state determination 216. The instructions of the baseline measurement 212 are executed when the door 102 is known to be closed to establish baseline values for distance to the back wall 118, amplitude of the reflected signal 132, etc. A user of the door lock 106 triggers the processor 208 to execute the instructions of the baseline measurement 212 as part of initialization of the door lock 106. The instructions of the baseline measurement 212 cause the processor 208 to trigger transmission of the signal 130 and analyze the reflected signal 132. A time-of-flight value, a reflected signal amplitude value, and other information is provided to the processor 208 by the distance measurement circuitry 202. The processor 208 stores the information received from the distance measurement circuitry 202 in the storage 210 as baseline values for use in determining whether the door 102 is closed.

Some implementations of the baseline measurement 212 cause the processor to compute a distance value based on the time-of-flight information provided by the distance measurement circuitry 202. For example, distance may be computed based on the propagation speed of the signal 130 and the time-of-flight value received from the distance measurement circuitry 202. The processor 208 executes the instructions of the distance measurement 214 to compute distance between the signal emitter 120 and the back wall 118. In some implementations, the time-of-flight value received from the distance measurement circuitry 202 serves as the distance value.

Instructions of the door state determination 216 are executed by the processor 208 to determine whether the door 102 is closed or open. Execution of the instructions of the door state determination 216 are triggered by movement of the bolt 108 from a retracted position to an extended position. In some implementations of the control circuitry 200, the processor 208 controls operation of the bolt actuator 218. The bolt actuator 218 is coupled to the bolt 108, and the processor 208 triggers the bolt actuator 218 to move the bolt 108 from the retracted position to the extended position. Thus, the processor 208 knows when the bolt 108 is being extended and triggers the distance measurement circuitry 202 to measure time-of-flight of the reflected signal 132 when the bolt 108 has been extended. In some implementations of the door lock 106, the bolt 108 may be manually moved by operation of a knob, lever, or other manual control. In such implementations, the control circuitry 200 includes a sensor (e.g., a Hall Effect sensor) coupled to the processor 208 that senses extension of the bolt 108 and notifies the processor 208 of the extension. On notification of extension of the bolt 108, the processor 208 executes the instructions of the door state determination 216 to determine whether the door 102 is open or closed.

The instructions of the door state determination 216 cause the processor 208 to communicate with the distance measurement circuitry 202, and trigger the distance measurement circuitry 202 to generate the signal 130 and produce a time-of-flight value, an amplitude value, and/or other values based on the reflected signal 132. The distance measurement circuitry 202 provides the time-of-flight value, the amplitude value, and/or other values based on the reflected signal 132 to the processor 208. The processor 208 compares the values received from the distance measurement circuitry 202, and or derivative values such as a distance value, to the baseline values generated as part of initialization of the door lock 106. If the distance to the back wall 118 is within a predetermined range of the baseline distance value, then the door 102 is deemed to be closed, otherwise the door 102 is deemed to be not closed. Similarly, if a value, such as amplitude of the reflected signal 132, deviates substantially from a baseline amplitude value, then the operating environment of the door lock 106 may be deemed to have been tampered with or otherwise changed.

The processor 208 communicates with devices external to the door lock 106 via the wireless network adapter 220. In some implementations, the wireless network adapter 220 is a wireless transceiver that communicates in accordance with an IEEE 802.11 protocol, or other protocol suitable for wireless communication between the door lock 106 and other devices. For example, if the bolt 108 moves from the retracted position to the extended position, and the processor 208 determines that the door 102 is not closed, then the processor 208 may communicate, via the wireless network adapter 220, with a user device, such as a smartphone, to inform the user that the bolt 108 is extended, but the door 102 is not closed. Similarly, if evaluation of amplitude or other parameters of the reflected signal 132 indicates that the operating environment of the door lock 106 has changed, then the processor 208 communicates, via the wireless network adapter 220, with the user device to apprise the user of the change in environment.

The processor 208 may also receive commands via the wireless network adapter 220. For example, the processor 208 may receive, via the wireless network adapter 220, a command to lock the door 102. On receipt of such a command, the processor 208 activates the bolt actuator 218 to move the bolt 108 from the retracted position to the extended position, and executes the instructions of the door state determination 216 to ascertain whether the door 102 is closed and locked.

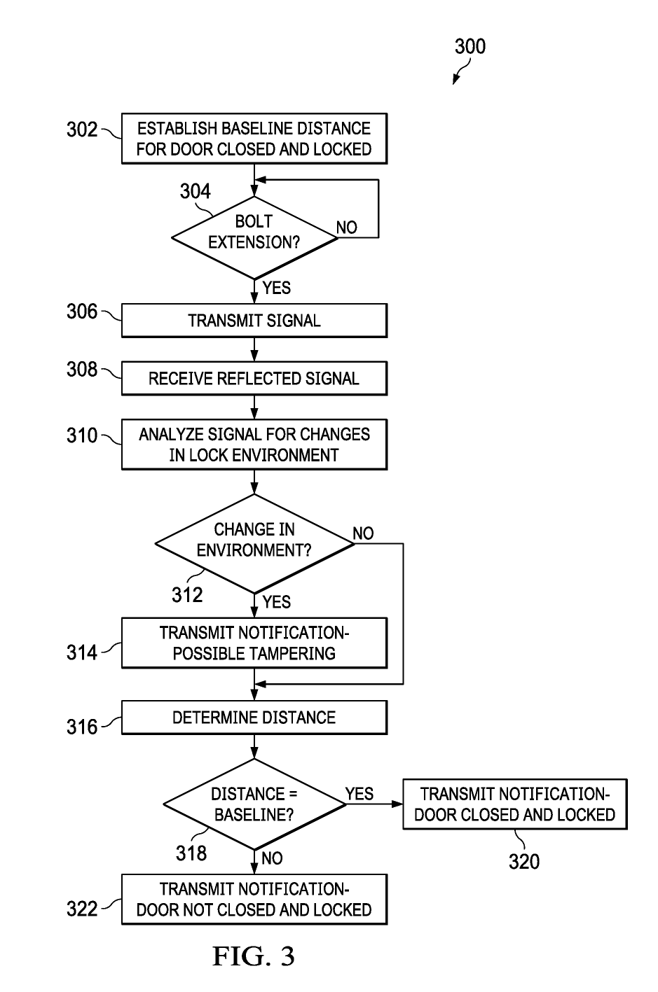

FIG. 3 shows a flow diagram for a method 300 for in accordance with the present disclosure. Though depicted sequentially as a matter of convenience, at least some of the actions shown can be performed in a different order and/or performed in parallel. Additionally, some implementations may perform only some of the actions shown. Operations of the method 300 may be performed by the door lock system door lock system 100.

In block 302, the door lock 106 establishes baseline values for the door 102 being closed and locked. Establishing the baseline values includes determining the distance between the back wall 118 and the signal emitter 120 and/or the signal detector 122 while the door 102 is closed and locked. One or more baseline values related to the operational environment of the door lock 106 may also be established for use in identification of potential tampering with the door lock 106 or its operating environment. To determine the distance between the back wall 118 and the signal emitter 120 and/or the signal detector 122, the processor 208 causes the distance measurement circuitry 202 to transmit the signal 130 through the channel 110 and the aperture 128, and receive the reflected signal 132 through the aperture 128 and the channel 110. The distance measurement circuitry 202 analyzes the reflected signal 132 to determine time-of-flight and other parameters of the reflected signal 132.

In block 304, the processor 208 is monitoring position of the bolt 108. If movement of the bolt 108 from the retracted position to the extended position is detected, then, in block 306, the processor 208 causes the distance measurement circuitry 202 to transmit the signal 130 into the channel 110 and through the aperture 128.

In block 308, the distance measurement circuitry 202 receives the reflected signal 132 reflected from the back wall 118 and passed through the aperture 128 and the channel 110. The distance measurement circuitry 202 generates a time-of-flight value, an amplitude value, etc. for the reflected signal 132, and transfers values derived from the reflected signal 132 to the processor 208.

In block 310, the processor 208 analyzes the values derived from the reflected signal 132 for indications of a change in the operational environment of the door lock 106. For example, if the amplitude of the reflected signal 132 has changed substantially with respect to a baseline amplitude value, then a change in the operational environment (e.g., the reflective surface back wall 118) may have occurred.

If, in block 312, analysis of the values derived from the reflected signal 132 indicate a possible change in the operational environment of the door lock 106, then the processor 208 transmits, via the wireless network adapter 220, a notification of possible tampering with door lock 106 in block 314.

In block 316, the processor 208 determines the distance between the back wall 118 and the signal emitter 120 and/or the strike plate 112 based on the time-of-flight of the reflected signal 132. In some implementations, the time-of-flight value may serve as the distance.

In block 318, the processor 208 compares the distance determined in block 316 to a baseline distance value. If the distance determined in block 316 is within a predetermined range (e.g., +/−10%) of the baseline distance value, then the processor 208 deems the door 102 to be closed, and, in block 320, the processor 208 transmits, via the wireless network adapter 220, a notification of the door 102 being closed and locked.

If the distance determined in block 316 is not within the predetermined range of the baseline distance, then the processor 208 deems the door 102 to be not closed, and, in block 322, the processor 208 transmits, via the wireless network adapter 220, a notification of the door 102 being not closed and locked.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A door lock system, comprising:
a bolt comprising:
a first end that is extendible to engage a strike plate;
an opening at the first end; and
a channel extending from the opening longitudinally through the bolt;
transmitter circuitry coupled to the bolt, and configured to transmit a signal into the channel; and
receiver circuitry coupled to the bolt, and configured to detect a reflection of the signal returned through the channel.

2. The door lock system of claim 1, wherein:
the transmitter circuitry is configured to transmit an optical signal; and
the receiver circuitry is configured to detect a reflection of the optical signal.

3. The door lock system of claim 1, wherein:
the transmitter circuitry is configured to transmit an acoustic signal; and
the receiver circuitry is configured to detect a reflection of the acoustic signal.

4. The door lock system of claim 1, further comprising a processor coupled to the receiver circuitry, the processor configured to determine a distance traveled by the signal.

5. The door lock system of claim 4, wherein the processor is configured to determine whether a door is closed based on the distance traveled by the signal.

6. The door lock system of claim 4, wherein the processor is configured to identify a change in an operational environment of the bolt based on a change in amplitude of the reflection of the signal.

7. The door lock system of claim 4, wherein the processor is configured to:
acquire a baseline distance value corresponding to a door being closed and locked; and
compare the baseline distance value to the distance traveled by the signal to determine whether the door is closed and locked.

8. The door lock system of claim 1, wherein the processor is configured to:
detect movement of the bolt from a retracted position to an extended position; and
responsive to detection of the movement of the bolt:
trigger the transmitter circuitry to transmit the signal; and
determine the distance traveled by the signal.

9. A method, comprising:
transmitting a signal through an opening at an end of a bolt of a door lock;
receiving a reflection of the signal through the opening; and
determining whether a door is closed and locked based on the reflection of the signal.

10. The method of claim 9, further comprising:
determining a distance from a signal emitter to a reflective surface based on the reflection of the signal; and
determining whether the door is closed and locked based on the distance.

11. The method of claim 10, further comprising comparing the distance to a baseline distance value to determine whether the door is closed and locked.

12. The method of claim 11, further comprising initializing the baseline distance value by, while the door is closed and locked:
transmitting a signal through the opening at the end of a bolt of a door lock; and
receiving a reflection of the signal through the opening.

13. The method of claim 9, wherein the signal is an optical signal.

14. The method of claim 9, wherein the signal is an acoustic signal.

15. The method of claim 9, further comprising identifying a change in an operational environment of the door lock based on the reflection of the signal.

16. The method of claim 9, further comprising:
detecting movement of the bolt from a non-extended position to an extended position; and
responsive to detection of the movement of the bolt:
triggering transmission of the signal; and
determining the distance traveled by the signal.

17. A door lock, comprising:
a bolt comprising:
a first end;
a second end opposite the first end;
an aperture disposed in the first end; and
a channel extending from the aperture through the bolt;
an optical emitter disposed at the second end and aligned with channel; and
an optical detector disposed at the second end and aligned with the channel.

18. The door lock of claim 17, further comprising distance measurement circuitry comprising:
an output coupled to the optical emitter; and
an input coupled to the optical detector.

19. The door lock of claim 18, further comprising a processor coupled to the distance measurement circuitry.

20. The door lock of claim 19, further comprising:
a wireless transceiver coupled to the processor; and
an actuator coupled to the processor and to the bolt.
